(19) United States
(12) Patent Application Publication
(10) Pub. No.: US 2009/0259940 A1
(43) Pub. Date: Oct. 15, 2009

(54) MOBILE VIDEO APPLICATION SERVICE CREATION TOOL

(76) Inventor: Ian M. Moraes, Suwanee, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/236,477

(22) Filed: Sep. 23, 2008

Related U.S. Application Data
(60) Provisional application No. 61/028,596, filed on Feb. 14, 2008.

(51) Int. Cl. G06F 3/02; G06F 9/44

(52) U.S. Cl. 715/719; 717/100

(57) ABSTRACT

A tool that enables a technologically unsophisticated user to develop and deploy what could be considered a technically complex video application without requiring the user have knowledge in the workings of various programming technologies. A wizard-driven web-based approach to dynamically and intelligently generate video media (e.g., menus) for mobile devices, map user actions to defined functions, and intelligently create the application artifacts (VoiceXML scripts, JSP's) required that use the generated video menus. It can securely deploy the application artifacts to platforms accessible by the targeted mobile devices. Thus, using a point and click web-based tool, a complete video portal application for mobile devices can be developed and deployed in a few minutes by users who do not have developer expertise.

### CROSS-REFERENCE TO RELATED APPLICATIONS

This application claims the benefit and priority of U.S. Provisional Application for Patent that was filed on Feb. 14, 2008 and assigned Ser. No. 61/028,596, such application is hereby incorporated by reference. This application is related to the U.S. Application for patent that was filed on Feb. 10, 2006 and assigned Ser. No. 11/352,443 and the one that was filed on May 17, 2007 and assigned Ser. No. 11/749,785, and the one that was filed on Mar. 15, 2005 and assigned Ser. No. 11/080,744, all of which are incorporated herein by reference.

### BACKGROUND

Have you ever seen a VCR flashing the 12:00 display? Do you even know what a VCR is in this DVD, HD-DVD, DVR and BLUERAY digital world in which we live? A VCR is a video cassette recorder and was the first big break through in home video entertainment technology. Well, once the main technology was unveiled, such as 4 recording heads, etc., there was not much left for a manufacturer to differentiate themselves from its competitors other than by the inclusion of various features. Fancy remote controls, LED displays, extra tuners for picture-in-picture capabilities, stereo output jacks, etc. The question regarding the flashing 12:00 display is to highlight a phenomenon that often occurs in emerging technologies. This phenomenon is basically that the capabilities of a product generally extend beyond the user expectations and capabilities. Thus, the complexities associated with programming the time of day into a VCR was way over the head for the typical VCR user. Absent of such programming, the VCR would continuously display the flashing 12:00 display. Or, if someone did happen to go through the manual and step-by-step perform the necessary functions to program the time of day, the first time the unit was unplugged or power was lost at the premises, the flashing 12:00's would once again rear its ugly head.

This phenomenon is sometimes referred to as creeping elegance. In a nutshell, to differentiate a product on the market, a company may include features and capabilities for which the market place is simply not ready. In a product that becomes a commodity, such as VCR's (meaning that the majority of people have or want one), the problems with creeping elegance are exasperated. The creeping elegance phenomenon basically results in the incorporation of features into a product that simply are not used, exercised or exploited by the average user. The reasons for the lack of use can be based on the difficulty in using the feature, the complexity in figuring out the feature, the intuitive nature and the perceived relevance or value of the feature. If one or more of these ingredients are lacking from the user's perspective, the feature has a good chance of lying dormant. Thus, the cost associated with the inclusion of the feature into the product ends up being a waste to the manufacturer.

Today, this phenomenon is being manifested on a wide-scale in the cellular telephone market. Today, cellular telephones are actually two products rolled into one. One product is a cellular telephone, the other is a multi-function computer. Today's cellular telephones can include games, MP3 players, email applications, calculators, web browsers, picture albums, video players, etc. In addition, the use of the cellular telephone is so commoditized that many people are even abandoning the use of the wired technology in the home in favor of cellular technology. As a result, many owners and users of cellular telephones are completely unaware of or unable to utilize the vast capabilities included with the cellular telephone.

For instance, typical cellular or mobile telephones are configured to provide audio and/or video presentations (e.g., music and/or music videos) to users. Mobile telephone menus for selecting audio and/or video presentations are currently not sufficiently descriptive of the corresponding audio and/or video items. For example, current menus are in the form of text lists. Therefore, using such mobile telephone menus can be unappealing to mobile telephone users. In line with the creeping elegance phenomenon, if it is not easy, intuitive and useful, there is a great chance that the feature will not be used.

Furthermore, with the expanding capabilities of mobile telephones, and the increasing need in the art to improve the safe operation of the same—especially while the user is operating heavy machinery—such as an automobile, there is a need in the art for improving the user interface of a mobile telephone. In this context, this user interface involves any user to mobile telephone interaction. One of the big steps forward in meeting this need in the art is voice activated dialing. Such technology allows a user to dial a number without ever having to take his or her eyes off of the road or the baby at the pool. However, when the mobile telephone is presenting information back to the user, such as presenting menu selections, voice mail retrievals, email retrievals, etc., the user is often required to look at and navigate a text based menu interface. What is needed in the art is an interface that enables user to navigate through various interface functionalities without having to look at the display.

Another aspect of feature rich cellular telephone technology is the exploitation of the advanced cellular technology by other devices, such as voice mail servers or the like. For instance, a platform offered by the assignee of the present application supports the provision of voice, video and data applications. Video applications comprise both application logic (e.g., VoiceXML code) as well as media (e.g., video menus). When a subscriber places a 3G video call to the platform, a media server answers the call and starts a VoiceXML browser. Furthermore, VoiceXML application pages are requested from the platform. The requested application logic is executed and the associated media is presented to the cellular telephone or device initiating the 3G video call. The user or subscriber interacts with the displayed interface and such actions result in further application logic being executed and new media being presented or the call ends. In general, this describes, at a very high level, the operation of a mobile video application. Many cellular telephones are equipped with such capabilities.

However, development of a mobile video application is manual and tedious, time consuming, and requires a variety of technical skill sets such as programming in or of JSP, servlets, VoiceXML scripts, Video Menu tools, mobile device knowledge, etc. Because different types of skills are involved, this further increases the complexity and time for creating a mobile video application. This can readily result in a lack of use of the technology due to the creeping elegance phenomenon. Few tools are available that allow a user to visually describe requirements for mobile video applications such as mobile video portals. Development tools that provide automated and intelligent guidance for developing mobile video applications are lacking.

What is needed in the art is a tool that addresses these issues by creating mobile video applications (both media and applications) in an automated manner that does not require developer skills. Further, what is needed in the art is a tool for creating mobile video applications that expands the capabilities to a wider audience by exploiting an intelligent web-based GUI tool.

### SUMMARY

Various embodiments of the present invention are directed towards enabling a technologically unsophisticated user to develop and deploy what could be considered a technically complex video application without requiring to user to gain knowledge in the workings of various programming technologies. One embodiment provides a tool that uses a wizard-driven web-based approach to dynamically and intelligently generate video media (e.g., menus) for mobile devices, map user actions to defined functions, and intelligently create the application artifacts (VoiceXML scripts, JSP's) required that use the generated video menus. It can securely deploy the application artifacts to platforms accessible by the targeted mobile devices. Thus, using a point and click web-based tool, a complete video portal application for mobile devices can be developed and deployed in a few minutes by users who do not have developer expertise.

In another embodiment, the invention is incorporated into a system and enables users to create video applications without requiring the user to have knowledge of the underlying programming for the video application. The system includes a user interface over which a client device can interact with the system to provide or create video application definitions. The user interface may include a menu driven graphical user interface that enables a user to enter video application definitions by providing structural descriptions of the web application by selecting menu items, pointing and clicking, dragging and dropping or other similar interface actions—all requiring minimal or no knowledge of the underlying software and coding requirements. Further, the system includes a generator that receives the video application definitions and generates executable code for rendering of the video application. In a specific embodiment, the invention can be deployed on a platform, such as the ICE platform available from Movius Interactive Corporation. In such an embodiment, an application server provides a target interface to the video application and underlying operation of the video application and a media provides the target interface components to the target for rendering and receiving actions from the target for manipulating the video application.

### BRIEF DESCRIPTION OF THE DRAWINGS

FIG. 1 is a system diagram illustrating the components and the connectivity of an exemplary platform in which aspects of the present invention could be incorporated.

FIG. 2 is a system diagram illustrating the components and the connectivity of an exemplary platform supporting various aspects of the present invention.

FIG. 3A is a block diagram depicting an embodiment of a communication system that can serve as an environment for embodiments of the invention.

FIG. 3B is a block diagram depicting another embodiment of a communication system incorporating an embodiment of the invention.

FIG. 4 is a flow diagram illustrating one example of an implementation of an embodiment of the invention in view of providing/modifying a carrousel styled interface that can be defined and then presented on a mobile device.

### DETAILED DESCRIPTION

The various embodiments, aspects and features of the present invention, in general, are directed towards a tool that enables users to create and customize mobile video applications using a web-based graphical user interface. For purposes of this description, this tool, utility or application will be referred to as the Mobile Video Application Service Creation Tool (or MVASC Tool or simply tool). It should be appreciated that this nomenclature is simply provided for clarification purposes and although the assignee of the present invention may use such nomenclature to describe an actual product, the present invention is not limited by the particular features, aspects or operations that may be incorporated into that single exemplary embodiment.

Embodiments of the present invention provide an innovative tool to dynamically and intelligently generate video media (e.g., menus) for mobile devices, map user actions to defined functions, and intelligently create the application artifacts (VoiceXML scripts, JSP's) required that use the generated video applications. Video applications can take on a variety of forms and, some non-limiting examples include video menu system, video portals, video jukebox, video library, etc. In one embodiment of the present invention a wizard-driven web-based interface can be used to provide the operations available through the tool. Embodiments of the invention can securely deploy the application artifacts to other systems, modules or components.

Advantageously, various embodiments of the present invention can operate to enable a user with limited technical expertise in the field of software and web-content design/development, to create such mobile video applications. Thus, using an interface such as a point and click web-based tool, a complete video portal application for mobile devices can be developed and deployed in a few minutes by users who do not have developer expertise.

In an exemplary embodiment of the present invention, the system or tool employs a knowledge base and application usage data to automatically create the appropriate media and application code required for mobile video applications. Advantageously, the resulting video applications can be Java-based, servlet, JSP, VoiceXML applications that can present static, dynamic or streaming video content.

Various embodiments of the present invention may include varying functions or aspects. Some of the functions that may be incorporated into an exemplary MVASC Tool include:
(a) Creating mobile video application logic artifacts (e.g., VoiceXML scripts);
(b) Creating mobile video media (e.g., video menus);
(c) Creating mobile video applications using application templates;
(d) Providing predefined system functions; and
(e) Supporting various administrative functions.

More specifically, an exemplary embodiment of the invention may include the ability to create mobile video application logic artifacts (e.g., VoiceXML scripts). Such a function can allow a user to specify application logic to define the structural interface to the application. For instance, the user may define the relationship of menus and sub-menus, the navigation necessary to traverse from a menu to a sub-menu based on key presses. Further, this function can enable the user to define the operation of the application. For instance, the user can use predefined system functions, such as play content, perform outdial, or send SMS, to perform various tasks. For example, an embodiment of the tool incorporating this functionality may allow the creation of a main menu comprising the following menu items (as a non-limiting example): music, movies, news, sports, leisure, religion and games. In addition, each menu item may include defined key presses for accessing or actuating each menu item. The tool may also allow the mapping of key presses in a menu to a sub-menu. For example, a main menu may include key presses to access a sub-menu such as a separate set of menu items (top 10 titles, new releases and exclusive music content). This aspect of the function advantageously can enable the tool to create video portal applications with multiple menu levels and varying functionality.

An exemplary embodiment may include the ability for the user to receive a special SMS, for example, an SMS with a special discount code. An embodiment may also provide the ability for a user to insert divider clips with selectable options to move to the next and previous clips and to separate a sequence of video clips. Exemplary embodiments of the invention operate to generate XML configuration files representing a model of the application logic and necessary media. Advantageously, embodiments of the invention allows use of this tool by rapid application development techniques in the field and for requirements gathering and clarification. The resulting XML file can then also be used as requirements input for development. For application logic of VoiceXML mobile media applications, embodiments may automatically generate VoiceXML scripts and/or JSP's to accompany video menus. Further, it may map the key presses and actions defined to the VoiceXML elements and script. Embodiments may intelligently generate the VoiceXML scripts including grammars, prompts, and exception handling required for a VoiceXML application. The resulting scripts can then be run on a Media Server.

Another function that can be incorporated into various embodiments of the present invention includes the ability to create mobile video media (e.g., video menus). Using this function, a user of an exemplary embodiment of the tool can automatically generate video media for target mobile devices. The generated video media may be based on a user specified parameters such as, presentation (colors, background, etc.), text, inserted images along with audio prompts. The generated video media can then be used in the mobile video application function for incorporation into the structure or operation of the mobile video application.

In an exemplary embodiment, media templates can be provided. In addition, the media template may then be customized to create video menus for specific applications (e.g., video portal). Different menu styles (templates) can be offered to the user when creating a menu. Thus, with this aspect of the present invention, the user is not forced to start from scratch. Once the menus are defined or created, they can then be automatically converted to the correct format for the selected or target mobile device based on default media formats. Thus, the user is not required to identify, select or even be aware of a specific media format for a video menu. Rather, the user can simply identify the target device and the tool intelligently creates the menu in the appropriate media format.

In addition, the tool may provide a preview facility that can display the newly video menus or content without having to reload the web page by using Ajax technology.

Furthermore, embodiments of this function can also employ the use static video menus and content created using standard industry tools. Such standard industry tools, for instance may include Adobe After Effects, scenecast etc. In addition, the user is able to access on-line developer guides which describe the best practices for creating mobile video clips. This function may also include an upload facility including features for using pre-recorded audio prompts that can be incorporated into a library or into a particular design layout. Further, media in one format can be transcoded into a correct or compatible format. Further, the audio content can be provided through the use of audio prompt files or, if Text-to-Speech servers are deployed, the TTS can be used to generate the audio.

Another function of various embodiments of the tool includes the ability to create mobile video applications using application templates. Advantageously, this aspect of the invention allows a user to create a mobile video application without having to start from scratch. The tool offers an application template that can be filled in and with minor modifications used to quickly develop a new mobile video application. For example, an application template for a video portal application may include the following menu items: music, sports, horoscopes, games and news. Further, the application template can be customized with a specific brand and by adding new menu items (i.e, religion and movies).

Another function of various embodiments of the tool includes supporting features of other systems. For instance, the above-incorporated U.S. patent application Ser. No. 11/352,443 describes an Application Message Control Center to create application messages. This function of an exemplary tool can operate to create the video menus and VoiceXML scripts used in an application message for video application messages.

In addition, the above-incorporated U.S. patent application Ser. No. 11/749,785 describes a carousel type video portal application. This function of the tool supports the creation of such carousel type video portal applications by allowing the user to utilize a web-based interface to specify the carousel content (e.g., movies, music, news, horoscopes), the order of the content, as well as the next video carousel to link to when one of the carousel content items is selected. For example, if the music content is selected, the next carousel content can be specified such as Top Ten music, featured music, and exclusive music. It will also be appreciated that this function of the tool can be used to support the creation of mobile video advertising campaign applications.

Another function that can be incorporated into various embodiments of the invention is the provision of predefined system functions. One such predefined system function is providing access to streaming servers. For example, the tool can present existing configured streaming servers and allow mapping of menu options to configured streaming servers. In addition, the tool can present other functions and features, such as specific URLs to access web sites or web applications, voice recordings, video recordings, etc. These functions can then be used when developing mobile video applications by mapping these functions to keys on the video menu. An exemplary embodiment of the present invention automatically generates the code to support this feature.

Another such predefined system function is to generate Call Detail Records (CDRs) based on user activity (e.g., user key presses).

Yet another such predefined system function is to enable an interface to real-time billing servers. For example, an embodiment of the invention can present existing configured billing servers to the user and allow mapping of menu options and application events to configured real-time billing servers. These actions can then be used when developing mobile video applications by mapping these actions to keys on the video menu for example. An exemplary embodiment of the present invention automatically generates the code to support this feature.

Various embodiments of the present invention may supports one or more of the following-described administrative functions. On such administrative function operates to display the overall video application flow and business analytic components to map actual application usage data on menu options (from call detail records) and present them graphically on top of video menus. This function enables a user to easily identify usage by a key press and video menu in order to assist in the modification of menus (e.g., remove/replace unused menu options). Another such administrative function is the provision of a knowledge based driven approach that can recommend revised menu sequencing and flow based on an application usage (e.g., call detail records). Yet another administrative function is the deployment, such as secure ftp from the host on which embodiment is deployed, to Media and Application Servers to deploy application artifacts (video menus, VoiceXML scripts and JSP's). Further, an administrative function may provide an on-line tutorial for users.

In summary, this tool is an innovative tool that uses a wizard-driven web-based approach to dynamically and intelligently generate video media (e.g., menus) for mobile devices, map user actions to defined functions, and intelligently create the application artifacts (VoiceXML scripts, JSP's) required that use the generated video menus. It can securely deploy the application artifacts to Media Servers and Application Servers. Thus, using a point and click web-based tool, a complete video portal application for mobile devices can be developed and deployed in a few minutes by users who do not have developer expertise.

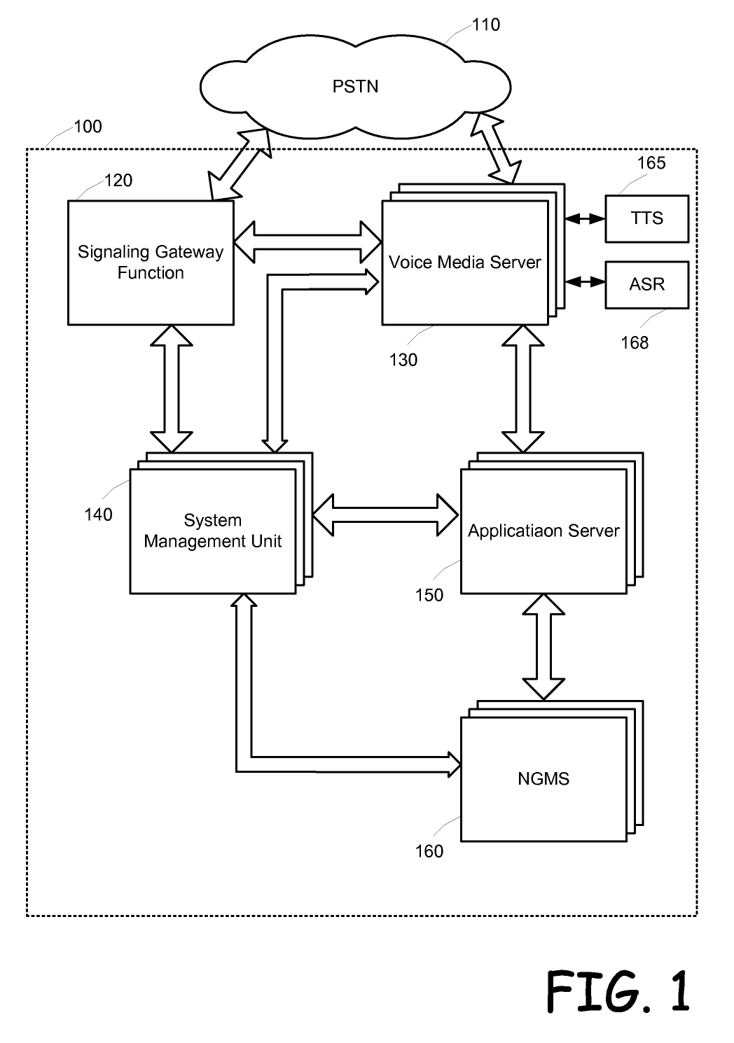

FIG. 1 is a system diagram illustrating the components and the connectivity of an exemplary platform in which aspects of the present invention could be incorporated. In the illustrated embodiment, the platform 100 employs a distributed IP architecture and is connected to the Public Switched Telephone Network (PSTN) 110. The communications platform 100 is illustrated as including a signaling gateway function (SGF) 120, one or more media servers (MS) 130, one or more system management units (SMU) 140, one or more application servers (AS) 150 and one or more next generation message stores (NGMS) 160.

In general, the SGF 120 serves as the Signaling System 7 (SS7) interface to the PSTN 110. The media server 130 terminates IP and/or circuit switched traffic from the PSTN via a multi-interface design and is responsible for trunking and call control. The application server module 150 generates dynamic VoiceXML pages for various applications and renders the pages through the voice media server 130 and provides an external interface via a web application server configuration. The SMU 140 is a management portal that enables service providers to provision and maintain subscriber accounts and manage network elements from a centralized web interface. The NGMS 160 stores voice messages, subscriber records, and manages specific application functions including notification.

The voice media server 130 terminates IP and circuit-switched voice traffic and is responsible for call set up and control within the system. The voice media server 130 processes input from the user in either voice or DTMF format (much like a web client gathers keyboard and mouse click input from a user). It then presents the content back to the user in voice form (similar in principle to graphic and text display back to the user on a PC client). This client server methodology enables rapid creation of new applications and quick utilization of content available on the World Wide Web.

The voice media server 130 processes incoming calls via requests to the application server 150 using HTTP. A load balancer directs traffic arriving at the voice media server 130 to one of a plurality of applications servers 150. This functionality ensures that traffic is allocated evenly between servers, and to active servers only. The voice media server 130 works as the VoiceXML client on behalf of the end user in much the same manner as a client like Netscape works on behalf of an HTML user on a PC. A VoiceXML browser residing on the voice media server 130 interprets the VoiceXML documents for presentation to users.

The voice media server 130 interfaces with the PSTN, automatic speech recognition server (ASR) 168 and text-to-speech server 165 (TTS) and provides VoIP (SIP, H.323) support. Incoming circuit switched voice data in 64-kilobit micro-law or A-law pulse code modulation (PCM) format is compressed using G.726 for voice storage in the NGMS 160. VoIP is supported through G.711 and G.723 voice encoding. The voice media server 130 contains a built-in abstraction layer for interface with multiple speech vendors—eliminating dependency on a single ASR 168 or TTS 165 vendor.

The voice media server 130 can include built in codecs and echo cancellation. Call detail records (CDRs), used by service providers for billing purposes, are provided as well as SNMP alarming, logging, and transaction detail records.

Each of these sub-systems is described in more detail in the U.S. patent application Ser. No. 11/080,744 which is incorporated by reference.

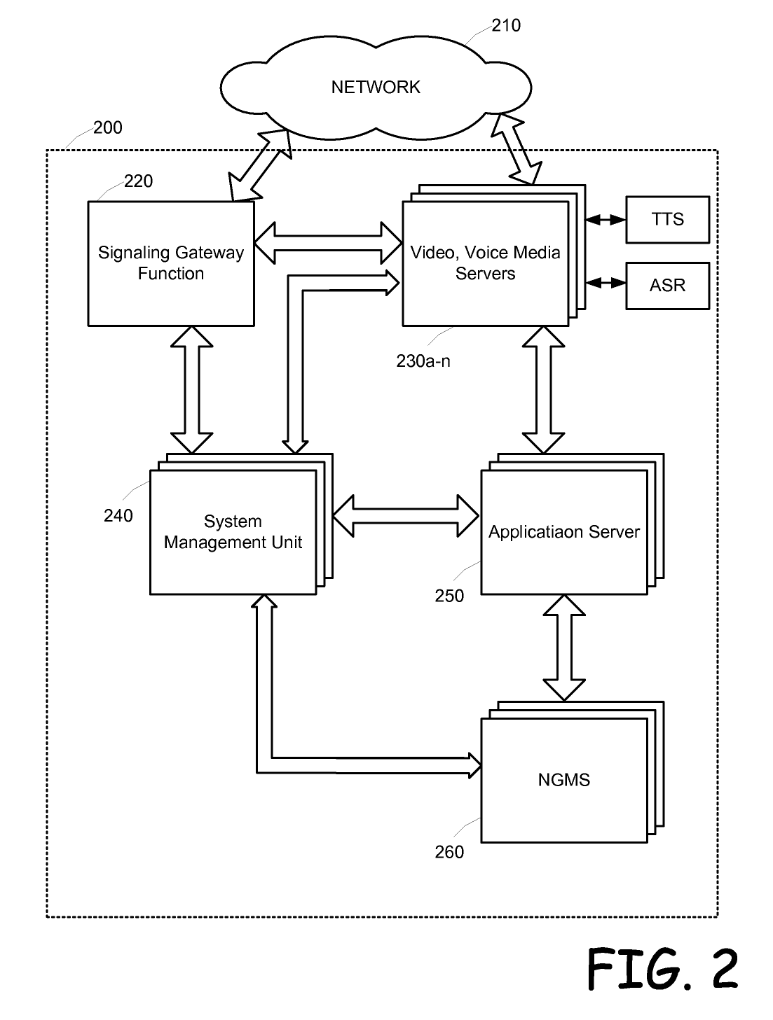

FIG. 2 is a system diagram illustrating the components and the connectivity of an exemplary platform supporting various aspects of the present invention. In the illustrated embodiment, the platform 200 employs a distributed IP architecture and is connected to a network 210. The communications platform 200 is illustrated as including a signaling gateway function (SGF) 220, one or more media servers (MS) 230a-n, one or more system management units (SMU) 240, one or more application servers (AS) 250 and one or more next generation message stores (NGMS) 260.

In general, the SGF 120 serves as the Signaling System 7 (SS7) interface to the network 120. The media servers 230 terminate IP and/or circuit switched traffic from the network via a multi-interface design and is responsible for trunking and call control. In addition, the media servers 230 render interface information to an end user device. For instance, during a voice telephone call a media server may render VoiceXML content. During a video call a media server may render media content of various types, with our without VoiceXML content.

The application server module 250 generates dynamic VoiceXML pages, recalls VoiceXML pages from memory and recalls various media content from memory for various applications and renders the pages through the media servers 230a-n. Furthermore, the application server module 250 may provide an external interface via a web application server configuration. Through this interface, a user may access the various features or functions for creating video media applications. For instance, the user may define the navigational menus, animation associated with various menu items, etc. The SMU 240 is a management portal that enables service providers to provision and maintain subscriber accounts and manage network elements from a centralized web interface. The NGMS 260 stores voice messages, subscriber records, and manages specific application functions including notification.

The voice media server 230 terminates IP and circuit-switched voice traffic and is responsible for call set up and control within the system. The voice media server 230 renders the user defined video media applications and processes input from the user in either voice or DTMF format (much like a web client gathers keyboard and mouse click input from a user). It then presents the content back to the user in voice and/or video form (similar in principle to graphic and text display back to the user on a PC client). This client server methodology enables rapid creation of new applications and quick utilization of content available on the World Wide Web.

The media server 230 may process incoming calls via requests to the application server 250 using HTTP. A load balancer can be used to direct traffic arriving at the voice media server 130 to one of a plurality of applications servers 250. This functionality ensures that traffic is allocated evenly between servers, and to active servers only. The media server 130 works as the VoiceXML and media client on behalf of the end user in much the same manner as a client like Netscape works on behalf of an HTML user on a PC. A browser residing on the voice media server 130 interprets the VoiceXML and media documents for presentation to users.

Thus, the platform as structured in FIG. 2 can support voice, video and data applications. The video applications include both application logic, such as VoiceXML code, as well as media, such as video menus, video services, etc. When a subscriber places a call, such as a 3G video call, that is received by the platform, the media server 230 answers the call and starts a VoiceXML browser. Further, the media server 230 requests VoiceXML application pages from the application server 250. The application logic is executed and the associated media is presented. As subscriber actions are received, the actions result in further application logic being executed and new media being presented or the call is ended.

As mentioned, the development of these mobile video applications is a manual, labor intensive and highly technical effort. Thus, many typical users of mobile video equipped equipment are not trained or knowledgeable in the development and production of such mobile video applications. However, it would be of great benefit for users to be able to exploit such functionality. To do so, the user would typically be required to gain expertise in skill sets such as JSP, servlets, VoiceXML scripts, Video Menu tools, mobile device knowledge, etc. Because so many different types of skills are involved, this further increases the complexity and time for creating a mobile video application. Advantageously, the various embodiments of the present invention provide tools that allow a technically unsophisticated user to visually describe requirements for mobile video applications, such as mobile video portals.

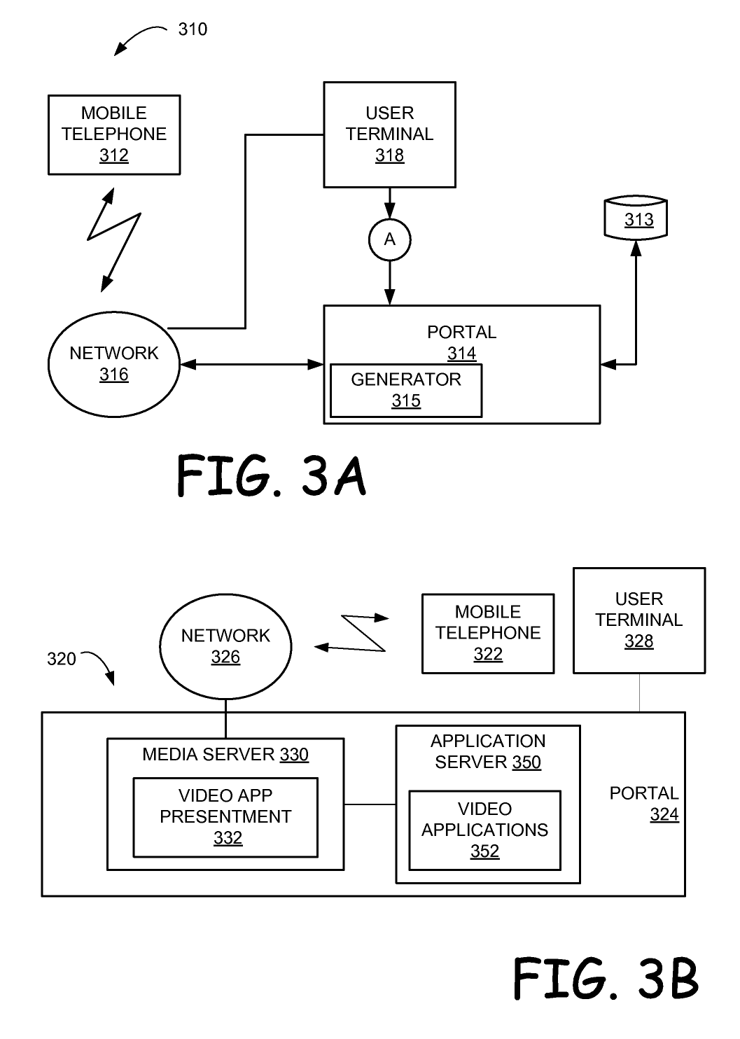

FIG. 3A is a block diagram depicting an embodiment of a communication system that can serve as an environment for embodiments of the invention. One such embodiment includes a tool for creating video applications and video content. The tool includes or exercises a user interface to a user terminal or client device 318. Over this interface the tool can receive information, such as but not limited to, (a) structural definitions for a video application, (b) the identification of a target mobile device and, (b) various content including video, audio, text, etc. For instance, the information may define a hierarchy for a menu and sub-menu interface.

In addition, the tool can provide information and interface information to the client device 318 over this interface. For instance, in one embodiment the tool includes a graphical user menu interface system. In such an embodiment the various interface screens are provided to the client device 318. In addition, the user interface can be used to provide template information that at least partially may define a video application. The user interface can also receive modifications to the template from the client device 318.

The tool may include a content store 313 or database, or have access to such content store 313 for a variety of functions, which may include, housing of content, content libraries or content sources, as well as storing uploaded content received from other sources or over the user interface. The content store may also include one or more system functions that can be selected by a user and associated with aspects of the video application, such as a menu item or a key press or key sequence, or a signal associated with a target device.

The tool may include a generator or engine 315 that operates to receive the structural definitions and selected video content and generate executable code for rendering of the video application. The generator may be operable to generate executable code that is compatible with the target mobile device. Further, the generator may be operable to incorporate selected system functions into the generated executable code.

The communication system 310 includes a mobile device 312 and a portal 314. The portal 314 can take on a variety of forms including a website, a server, a particular portal application, etc. A general industry definition describes a portal as a central place for making a variety of types of information accessible to an audience of varying range. Under this definition, portals can be viewed in two major classifications: the enterprise information portal and the content management portal. In reality, portals can take on either form or a combination of both. Enterprise information portals are primarily intended to centrally locate a large amount of information, potentially from varying sources, all at a single location—and often times presented from a main screen that enables others to dig for additional underlying information. The users of this information typically do not publish to this type of portal; rather, they are the consumers of the information prepared and published by others. A popular example of a commonly used enterprise information portal would be the web site developed by GOOGLE. At the GOOGLE web site, one can obtain up-to-the-minute data from financial institutions, weather feeds, and other sources all over the globe.

Content management portals primarily focus on providing access to and the sharing of information. In a content management portal, self-service publishing features allow end users to post and share any kind of document or Web content with other users, even those geographically dispersed.

In the context of embodiments of the present invention, a portal can be considered to be any of a variety of enterprise portals, content management portals, or simply a computer system or server accessible over a network that provides an opening to a user to utilize an application, content, or information that is either stored on the system or accessible through the system.

The mobile device 312 is coupled to the portal 314 via the communication network 316. The mobile device 312 is, for example, a mobile telephone. The communication network 316 comprises one or more communication networks such as a PSTN (public switched telephone network) and/or a wireless telephone network. The portal 314 provides mobile video content and applications to the mobile device 312 via the communication network 316.

Among other things, the portal 314 enables dynamically loading content and presenting it for browsing and selection by the user. An operator may modify the available content at the portal by loading new content, adding-to or replacing existing content, altering currently available content and/or removing content. In addition, an embodiment of the mobile video application service creation tool enables a user or subscriber at user terminal 318 to also modify the available content at the portal by loading new content, adding-to or replacing existing content, altering currently available content and/or removing content. It should also be appreciated that the mobile device or mobile telephone 312 may also be used as a terminal for making such changes.

FIG. 3B is a block diagram depicting another embodiment of a communication system incorporating an embodiment of the invention. The communication system 320 includes a mobile device 322 and a portal 324. The portal 324 includes a media server 330 and an application server 350. The media server 330 is coupled to the mobile device 322 via a communication network 326. The application server 350 includes one or more mobile video applications 352 which are configured to cause the media server 330 to provide the video application presentment 332 to the mobile telephone 322 via the communication network 326. In an alternative embodiment, the video application presentments can be stored outside the media server 330. In addition, an embodiment of the mobile video application service creation tool enables a user or subscriber at user terminal 328 to also modify the available content at the portal by loading new content, adding-to or replacing existing content, altering currently available content and/or removing content. It should also be appreciated that the mobile device or mobile telephone 322 may also be used as a terminal for making such changes.

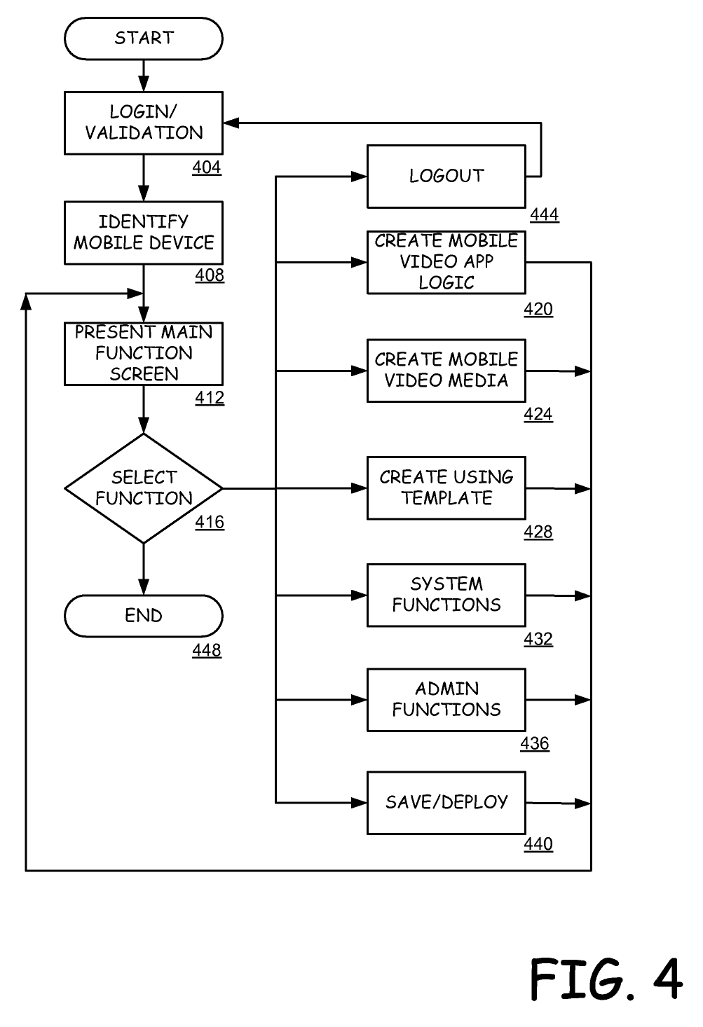

FIG. 4 is a flow diagram illustrating one example of an implementation of an embodiment of the invention in view of providing/modifying a carrousel styled interface that can be defined and then presented on a mobile device. Initially, the process 400 begins by a user logging into to the system and being validated as an authorized user 404. Logging into the system may include logging onto a portal, such as portal 314 or 324 using the user terminal 318 or 328 respectively. At some point in the process, the user should identify the type of mobile device for which the video content or application is being created 408. Alternatively, this information may be part of the users profile and thus, is known upon a successful login of the user. In addition, some embodiments may not require logging in, and thus, some means must be included for the user to indicate the target mobile device for the video content. Alternatively, the video content may be prepared for a generic device and then upon selecting or activating the content, the target mobile device can be made known, the content modified and then delivered.

Once the system is accessed, an embodiment of the invention may present the user with a list of features, functions or options available as tools for creating mobile video applications or services 412. For instance, the menu of items may include one or more of the following:
(a) Create mobile video application logic artifacts;
(b) Creating mobile video media;
(c) Creating mobile video applications using application templates;
(d) System functions;
(e) Administrative functions;
(f) Save/Deploy; or
(e) Logout.

The user can then select an available option 416. If a user selects the option to create mobile video application logic artifacts 420, the user may navigate to another menu to allow the user to enter definitions for the menus and sub-menus, the relationship between them and the functions used to navigate between them. This information can be provided in a variety of manners. For instance, one embodiment may provide a GUI to allow a user to graphically represent the logic and structure. In another embodiment, a table may be used to define elements and show mappings between the elements. It should be appreciated that many implementations can be used including the afore-mentioned methods, as well as others such as importing the data from another file or application, presenting a template and accepting modifications thereto, receiving a hierarchical list, etc. In each embodiment, an aspect of the invention is that the user is not required to code the VoiceXML required to define these elements, structure or relationships. Thus, a simple, easy to understand interface allows the user to define a structure that could require significant expertise to represent in VoiceXML. Rather, the system creates an XML file to represent the defined logic. The resulting XML file can then also be used as requirements input for development. For application logic of VoiceXML mobile media applications, embodiments may automatically generate VoiceXML scripts and/or JSP's to accompany video menus. Further, it may map the key presses and actions defined to the VoiceXML elements and script. Embodiments may intelligently generate the VoiceXML scripts including grammars, prompts, and exception handling required for a VoiceXML application. The resulting scripts can then be run on a Media Server. Upon completion, the process 400 returns to step 412 where the main menu can be redisplayed and a selection received.

If the user selects the option to create mobile video media 424, the user can then use various applications to create video content or import video content to be incorporated into the defined menu structure. For instance, if the user has defined a menu structure, the user can select this option to associate video content and audio content with the various menu items. The selections made here are rendered on the user's mobile device when the various menu items are displayed or selected. Upon completion, the process returns to step 412.

A user may also select the option to utilize a template to create video applications 428. Upon selecting this option the user can be presented with a template and a list of commands to add elements, delete elements, modify elements, move elements, change the relationship between elements, change the key presses to select elements, change the video and/or audio content associated with the elements, etc. Upon completion, the process returns to step 412.

If the user selects system functions 432, the user may be presented with a list of predefined functions that can be incorporated into the video application. Alternatively or in addition to, the user may be presented with a list of categories for various system functions. If the user selects administrative functions 436, the user may be presented with a list of various administrative functions that the user can select. Upon completion, the process returns to step 412.

Upon completing one option, the user can go back and edit or change the video application by selecting other options. Finally, the user can elect to save the video application 440. Upon such selection, the video application is converted to a format that is suitable access and rendering on the target mobile device or, is converted to a format that can be easily transformed to a target mobile device specific format.

The user can logout 444 to result in the process returning to step 404 requesting a user to login or the process 400 can be terminated. When the video application is complete, the video application can be loaded onto or made available on a platform to be accessed by the mobile device. The user may also login and reload the video application to modify it. The user can modify the video application either using the terminal or by using the mobile device.

As a more specific example, the operation of an embodiment of the present invention in the creation of a carrousel structure. When presentations (video and/or audio) are provided to a user via a carrousel application, the user may select a particular item, skip to the next item, back-up to a previous item, or replay the current item. Selecting an item can lead to the purchase of the item, fulfillment of the item, or to other functionality, including, for example, another carrousel. In embodiments of the present invention, a user and/or developer (both referred to as a user within this context) can implement any desired number of carrousels to be provided by the portal 324.

The content of a carrousel is dynamic and flexible. A user can change all or part of the content of any specific carrousel, thereby increasing or decreasing the number of items in the carrousel. A carrousel application may provide multiple carrousels. Each carrousel can be independent of other carrousels, but can contain links to some of the same items presented by other carrousels. A carrousel is made up of the media items to be displayed in that carrousel. A carrousel configuration file lists the items in that carrousel as well as actions to be taken when a particular item is selected from the carrousel.

System functions may be associated with the various elements of the carrousel. For instance, the content of a carrousel may be controlled by selecting a search engine process for a particular item on the carrousel. Thus, an automated process for the element can be created by having a search engine or similar process feed items to or remove items from the carrousel. The automated process could constantly, periodically or occasionally search for or identify new content to be added to the carrousel or identify out of date or inapplicable items to be removed from the carrousel. Similarly, the user can associate a life span for an item in a carrousel and they may automatically be removed upon the expiration of that life span. In addition, the items in a carrousel may be monitored for activity and if the activity pertaining to a certain item does not meet certain parameters (e.g., selected a certain number of times over a period of time) it can be removed. Likewise, items that exceed other thresholds of activity may be used to augment the content of the carrousel. For instance, if a particular item is selected a threshold number of times over a given period of time, similar or related items may be identified and added to the carrousel. Thus, this aspect of the invention enables the user to create a dynamic video application that can change over time based on the user's actions. As a non-limiting example, the user could establish a play list of songs and depending on user actions such as hitting a skip button, fast forward or selecting certain items, the order of items in the play list can be changed.

To more specifically illustrate how the concept of the carrousel can be implemented, an exemplary embodiment of the invention is described; however, it should be appreciated that this is simply a non-limiting example. The user enters information to define the structure of the video application, such as the number of carrousels, the number of items in each carrousel, the categories of items in each carrousel, the type of carrousel (navigational or information/content). In essence, once defined the various elements of the carrousel structure define or represent place holders that can have individual items associated therewith.

Along with the media files for each exemplary carrousel, there may be a carrousel configuration file (CCF). The CCF has, for example, an XML format, and is used by the portal 114 to load the media into the specified carrousel and to define the behavior of the carrousel when a user is navigating the carrousel. The CCF contains, for example, a carrousel “name”, a space for a carrousel number, and entries for each of the media items in the carrousel.

A carrousel name is an alphanumeric string that is easily readable and understandable by an operator and describes the contents of the respective carrousel. A carrousel that contains movies available during a current week can be named, for example, “ThisWeekMovies.” As another example, a carrousel that contains a collection of items (e.g., wallpapers, songs, videos, etc.) corresponding to the artist “Samson” can be named “SamsonMedialtems.” Once a name is assigned to a carrousel, it can be used as the name of that carrousel indefinitely. A content provider can then update the contents of the carrousel and create a CCF for the carrousel using the assigned carrousel name.

The mobile video can be created, uploaded are accessed from a library. For instance, in one embodiment, each of the individual “items” in an exemplary carrousel is in a “ready-to-play” format described, for example, in a media format guide. Each carrousel item, whether it be an end “content” item or a navigational item, comprises a properly formatted video file (e.g., in a.glv format) and/or a corresponding audio file (e.g., in a.glu format). These two files can have the same filename, but with different extensions (e.g., .glu or .glv) that indicate the respective format. For example, a media clip corresponding to the artist “Samson” is named “SamsonSong1” and has two corresponding media files: “SamsonSong1.glu” (the audio portion of the clip) and “SamsonSong1.glv” (the video portion of the clip). Therefore, a carrousel of 10 items can have 20 associated media files: 10 video files and 10 audio files. In an exemplary embodiment, the carrousel structure can be displayed to the user, along with a list of available media items. The list may allow sorting, filtering, searching, browsing or uploaded to specifically identify desired content. The user can drag and drop items from the list onto the placeholders of the carrousel.

System functions may also be associated with carrousel items. For instance, an entry in the carrousel may invoke a search of the top 10 songs for the week and then update a song list in the carrousel. When operating an embodiment of the present invention, the user may be able to view a list of available functions and drag and drop one or more of these functions onto the carrousel structure. Some functions may require the user to enter parameters at the time of associating the function with the carrousel and others may request parameters at the time of selection or actuation by the user of the mobile device. Yet other functions may not require parameters at all.

Once completed, the video application can be made available for the target mobile device. The coding and conversions for all elements happens in the background transparent to the user.

Another inventive aspect of this disclosure includes a video portal. This inventive aspect provides a web tool for users to use to create their own personal mobile video portal. In a typical embodiment, a user would be able to use a web interface to create their portal and upload content and/or record video messages, format the structure for accessing content by enabling the user to create and deploy menus and the look-and-feel of the portal for various access tools (such as a computer browser or a handheld portable device). In one embodiment, the user can then call in via a video call using a video call compatible telephone and see their portal and content.

More specifically, this inventive aspect includes a web tool that enables a user to create his or her own video portals, upload video content, organize the content, control the content and develop content. For instance, the content can be controlled by defining the size of the video screen, the quality of playback, etc. This tool allows a user to create the portal by incorporating content into the portal. For instance, in one embodiment, the user can incorporate content by dragging and dropping desired or selected content into or onto the portal through a web browser. The content can come from any of a variety of sources.

Embodiments may allow the user to customize the mobile device interface through the web browser. For instance, a window can be selected and displayed for the user to view how the content will be rendered or will look on the mobile device. Thus, the entire portal, links, content, etc. can be controlled and modified using a web browser. Further, the manner in which the content will appear on the mobile device can be observed and modified using the web portal and/or by actually engaging in a video call. In one embodiment, the user can open a mobile window for one of a plurality of devices or, open multiple windows for different devices to optimize the video portal across a set of devices. While a window is open, the user can drag content from location to location, stretch or shrink content, windows or the display area, modifying menu structures, etc. The video content on the portal can be delivered via links or more typically during a video call.

Embodiments of the invention can also provide control for live content. For instance, a window can be defined in the portal for the display of a live video feed, such as a movie, a video camera feed, or a live video conference.

The present invention has been described as being an integral part of, or integrated with, the platform in which the video applications created by embodiments of the invention are deployed. However, it will be appreciated that embodiments of the present invention may also be incorporated into a stand alone system. In such an embodiment, a user may create video applications off-line and independent from the platform. Once the video application is ready, it can then be uploaded to a platform for rendering the video application. As such, the present invention can be embodied in the form of a web application, a utility that is provided on a media and then loaded into a computer, a dedicated system, etc.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A tool for creating video applications and video content, the tool comprising:
a user interface for receiving structural definitions for a video application;
a content store for housing a plurality of video content; and
a generator that is operable to receive the structural definitions and selected video content and generate executable code for rendering of the video application.

2. The tool of claim 1, wherein the structural definitions include the identification of a target mobile device and, the generator is operable to generate executable code that is compatible with the target mobile device.

3. The tool of claim 2, wherein the user interface is further operable to present at least one template that at least partially defines the structure of a video application.

4. The tool of claim 3, wherein the user interface can receiving structure definitions for the video application by receiving modifications to a template.

5. The tool of claim 2, wherein the content store can receive uploaded content from a user.

6. The tool of claim 5, wherein the uploaded content can be video, audio or graphic content.

7. The tool of claim 2, wherein the content store provides a library of video, graphic and audio content.

8. The tool of claim 2, wherein the content store includes at least one system function and the structural definitions includes an association of at least one menu item with the system function.

9. The tool of claim 8, wherein the generator is operable to incorporate the system function into the generated executable code.

10. The tool of claim 9, wherein the structural definitions include defining a hierarchy for a menu and sub-menu interface.

11. A system for enabling a user to create video applications without requiring the user to have knowledge of the underlying programming for the video application, the system comprising:
a user interface operable to interact with a client device over a network and receive video application definitions;
a generator that is operable to receive the video application definitions and generate executable code for rendering of the video application;
an application server that is operable to provide a target interface to the video application and underlying operation of the video application; and
a media server for providing the target interface components to the target for rendering and receiving actions from the target for manipulating the video application.

12. The system of claim 11, wherein the user interface includes a menu driven graphical user interface that enables a user to enter video application definitions by providing structural descriptions of the web application.

13. The system of claim 12, wherein at least one menu item in the menu driven graphical user interface presents at least one template that at least partially defines the structure of a video application and enables a user to select the template.

14. The system of claim 13, wherein the user interface further enables a user to modify the template.

15. The system of claim 14, wherein the user interface further enables a user to select video content to be included in the video application definition.

16. The system of claim 15, wherein the user interface further enables a user to upload video content that can be selected by the user.

17. The system of claim 14, wherein the user interface further enables a user to select a service to be included in the video application definition.

18. The system of claim 12, wherein in the video application definitions provide a mapping of functions available by the video application and signals received over the target interface, and in response to signals received over the target interface, the media server is operable to invoke the video application and interact with the application server to obtain video data, present the video data to the target, receive further signals from the target and to interact with the application server in accordance with the mapping of the functions and signals received.

19. A system for enabling a user to create video applications without requiring the user to have knowledge of the underlying programming for the video application, the video applications being accessible by a mobile device the interacts with the video application by providing mobile device signals and receiving video content, the system comprising:
a user interface operable to interact with a client device over a network and receive video application definitions including structural definitions and mappings between functions and received mobile device signals; and
a generator that is operable to receive the video application definitions and generate executable code for rendering of the video application.

20. The system of claim 19, wherein the user interface is operable to receive video content and, the generator is operable to generate executable code an include video content received through the user interface.
